(19) United States
(12) Patent Application Publication
(10) Pub. No.: US 2024/0194910 A1
(43) Pub. Date: Jun. 13, 2024

(54) FUEL CELL SYSTEM AND HYDROGEN TANK TEMPERATURE CONTROLLING METHOD THEREOF

(71) Applicant: HYUNDAI MOBIS CO., LTD., Seoul (KR)

(72) Inventor: Yong Hee LEE, Yongin-si (KR)

(73) Assignee: HYUNDAI MOBIS CO., LTD., Seoul (KR)

(21) Appl. No.: 18/496,401

(22) Filed: Oct. 27, 2023

(30) Foreign Application Priority Data
Dec. 7, 2022 (KR) 10-2022-0169458

(51) Int. Cl. H01M 8/04701; F17C 13/02; H01M 8/04082; H01M 8/04089; H01M 8/0432; H01M 8/0438; H01M 8/04746; H01M 8/04858

(52) U.S. Cl. CPC H01M 8/04708; F17C 13/025; F17C 13/026; H01M 8/04089; H01M 8/04201; H01M 8/04365; H01M 8/0438; H01M 8/04768; H01M 8/04888; F17C 2221/012; F17C 2227/0304; F17C 2227/0348; F17C 2250/032; F17C 2250/043; F17C 2250/0439; F17C 2250/0631; F17C 2270/0189

(57) ABSTRACT

A fuel cell system including a hydrogen tank configured to store hydrogen supplied to a fuel cell stack, a heater configured to heat the hydrogen tank, a cooler configured to cool the hydrogen tank by circulating cooling water, and a controller configured to adjust a temperature of the hydrogen tank by controlling the heater and the cooler responsive to a measured temperature of the hydrogen tank.

### CROSS-REFERENCE TO RELATED APPLICATION

This application claims the benefit under 35 USC § 119 (a) of Korean Patent Application No. 10-2022-0169458, filed in the Korean Intellectual Property Office on Dec. 7, 2022, the entire disclosure of which is incorporated herein by reference for all purposes.

### TECHNICAL FIELD

The present disclosure relates to a fuel cell system and a hydrogen tank temperature controlling method thereof.

### BACKGROUND

Fuel cell systems may generate electric energy using fuel cell stacks. For example, when hydrogen is used as a fuel for the fuel cell stack, the fuel cell stack may be alternative to solving global environmental problems, and thus R&D on the fuel cell systems has been continuously carried out.

The fuel cell system may include a fuel cell stack that generates electrical energy, a fuel supply device that supplies a fuel (hydrogen) to the fuel cell stack, an air supply device that supplies, to the fuel cell stack, oxygen in the air, which is an oxidizing agent required for electrochemical reaction, and a thermal management system (TMS) that removes reaction heat of the fuel cell stack to the outside of the system, controls an operating temperature of the fuel cell stack, and performs a water management function.

The fuel cell system may include a hydrogen tank for supplying the hydrogen to the fuel cell stack, the hydrogen is a power source of power in the fuel cell system, and thus it is required to manage a state of the hydrogen tank storing the hydrogen.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a fuel cell system including a hydrogen tank configured to store hydrogen supplied to a fuel cell stack, a heater configured to heat the hydrogen tank, a cooler configured to cool the hydrogen tank by circulating cooling water, and a controller configured to adjust a temperature of the hydrogen tank by controlling the heater and the cooler responsive to a measured temperature of the hydrogen tank.

The cooler may include a cooling line comprising a first cooling line through which the cooling water circulates to pass through an electrical component and a second cooling line connected to the first cooling line and configured to circulate the cooling water through the hydrogen tank, a pump disposed on the cooling line and configured to pump the cooling water, and a branching valve configured to open or close to circulate the cooling water within the second cooling line.

The controller may be configured to not supply a voltage to the heater when a state of fuel (SoF) of the hydrogen tank is less than a first value and a charging rate of a battery is less than a second value.

The controller may be configured to not supply a voltage to the heater and open the branching valve at the same time.

The controller may be configured to control whether a voltage is supplied to the heater based on the temperature of the hydrogen tank and an outside air temperature.

The fuel cell system may include a pressure sensor configured to measure an external pressure, and the controller may be configured to estimate an altitude based on the external pressure and calculate the outside air temperature based on the estimated altitude.

The controller may be configured to supply the voltage to the heater so as to heat the hydrogen tank when the temperature of the hydrogen tank is less than a third value and the outside air temperature is less than a fourth value.

The controller may be configured to stop the supply of the voltage to the heater when the temperature of the hydrogen tank reaches a target value.

The target value is a temperature of the cooling water.

The controller may be configured to open the branching valve is opened based on the temperature of the hydrogen tank and a temperature of the cooling water.

The controller may be configured to open the branching valve to allow the cooling water to circulate to the second cooling line responsive to a calculated value being greater than a fifth value, the calculated value being based on a temperature change rate of the hydrogen tank and a difference between the temperature of the hydrogen tank and the temperature of the cooling water.

The controller may be configured to correct a number of rotations of the pump based on a length of the first cooling line and a length of the second cooling line when the branching valve is opened.

The controller may be configured to correct the number of rotations of the pump further based on the temperature of the hydrogen tank and the temperature of the cooling water.

The heater may include a positive temperature coefficient (PTC) heater.

In a general aspect, here is provided a processor-implemented method including acquiring a temperature of a hydrogen tank and controlling one of a heater configured to heat the hydrogen tank and a cooler configured to cool the hydrogen tank responsive to the temperature of the hydrogen tank.

The method may include adjusting a branching valve to allow cooling water to circulate to a first cooling line responsive to a calculated value being greater than a first value, the calculated value being based on a temperature change rate of the hydrogen tank and a difference between the temperature of the hydrogen tank and a temperature of the cooling water.

In a general aspect, here is provided a device including a processor configured to execute instructions and a memory storing the instructions, an execution of the plurality of instructions configures the processor to receive a measured temperature of a hydrogen tank and adjust a temperature of the hydrogen tank by controlling a heater and a cooler responsive to the measured temperature of the hydrogen tank, a first cooling line receiving cooling water from the cooler, the first cooling line being configured to circulate the cooling water through an electrical component, a branching valve configured to selectively provide the cooling water circulates to a second cooling line, and the second cooling line receiving the cooling water through the branching value and being configured to circulate the cooling water through the hydrogen tank.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a structure of a fuel cell system according to an embodiment disclosed in the present document;

FIG. 2 is a block diagram illustrating the fuel cell system according to the embodiment disclosed in the present document;

FIG. 3 is a flowchart for describing a hydrogen tank temperature controlling method of the fuel cell system according to the embodiment disclosed in the present document; and

FIG. 4 is a flowchart for describing a process of controlling a temperature of a hydrogen tank according to the embodiment disclosed in the present document.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component (s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof. Terms “module” or “unit” used herein may include a unit implemented in hardware, software, or firmware, and may be used interchangeably with terms such as logic, a logic block, a component, or a circuit. The module may be an integrally formed component or a minimum unit or a part of the component performing one or more functions. For example, according to an embodiment, the module may be implemented in the form of an application-specific integrated circuit (ASIC).

Various embodiments of the present document may be implemented by software (for example, a program or an application) including one or more instructions stored in a storage medium (for example, a memory or) that may be read by a machine. For example, a processor of the machine may call at least one instruction among one or more instructions stored in the storage medium and may execute the instruction. This enables at least one function to be performed according to the at least one called instruction. The one or more instructions may include a code that is made by a compiler or a code that may be executed by an interpreter. The storage medium that may be read by the machine may be provided in the form of a non-transitory storage medium. Here, the “non-transitory storage medium” merely means that the storage medium is a tangible device and does not include a signal (for example, an electromagnetic wave), and with regard to the term, a case in which data is semi-permanently stored in the storage medium and a case in which data is temporarily stored in the storage medium are not distinguished from each other.

However, in the case of a general fuel cell system, there is no component that may heat or cool a hydrogen tank for storing hydrogen supplied to a fuel cell stack, and thus the hydrogen tank cannot be maintained at a constant temperature. In particular, in a fuel cell system provided in an object operating in the sky, such as a flight vehicle, a value such as a state of fuel (SoF) of the hydrogen tank may be inaccurately calculated due to a decrease in the temperature of the hydrogen tank.

The technical problems to be solved by the present disclosure are not limited to the aforementioned problems, and any other technical problems not mentioned herein will be clearly understood from the following description by those skilled in the art to which the present disclosure pertains.

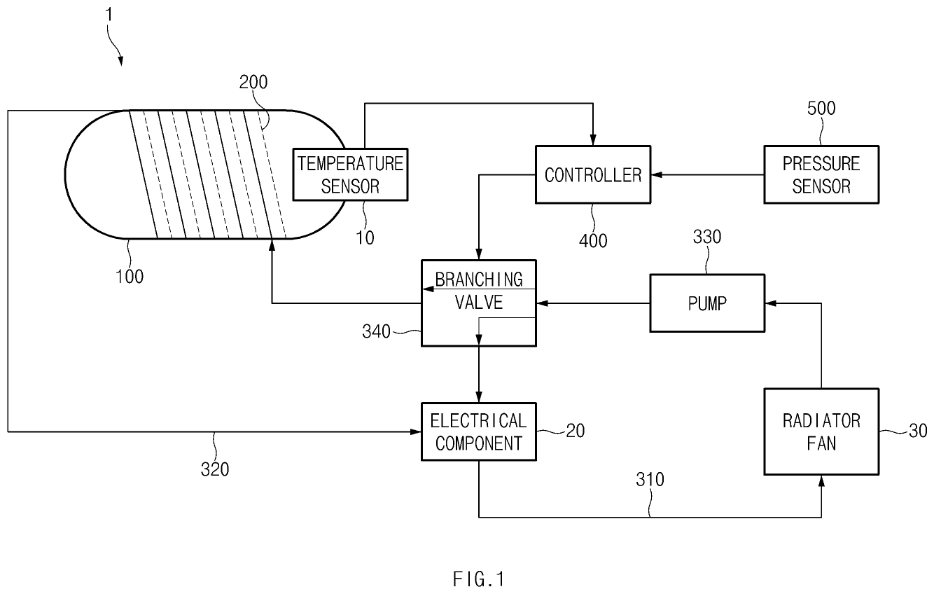

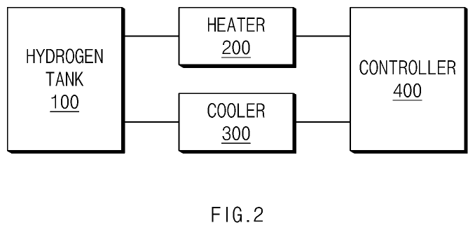

FIG. 1 is a view illustrating a structure of a fuel cell system according to an embodiment disclosed in the present document. FIG. 2 is a block diagram illustrating the fuel cell system according to the embodiment disclosed in the present document.

Referring to FIGS. 1 and 2, a fuel cell system 1 may control a heater 200 and a cooler 300 to adjust a temperature of a hydrogen tank 100. Therefore, the fuel cell system 1 may maintain the temperature of the hydrogen tank 100 at a constant temperature. Further, the fuel cell system 1 may maintain the hydrogen tank 100 at the constant temperature, thus accurately determine a state of the hydrogen tank 100, and accordingly, prevent inaccurate control.

According to the embodiment, the hydrogen tank 100 may store hydrogen supplied to a fuel cell stack (not illustrated). The hydrogen stored in the hydrogen tank 100 may be supplied to the fuel cell stack through a hydrogen supply line (not illustrated) of the fuel cell system 1, and the fuel cell stack may generate electricity through a chemical reaction.

According to the embodiment, the hydrogen tank 100 may include a temperature sensor 10. The temperature sensor 10 may acquire a temperature of the hydrogen tank 100. The temperature sensor 10 may transmit the acquired temperature of the hydrogen tank 100 to a controller 400.

According to the embodiment, the heater 200 may heat the hydrogen tank 100. The heater 200 may receive a voltage to generate heat to heat the hydrogen tank 100. The heater 200 may include a resistor that generates heat as the voltage is supplied (or as a current flows). As an example, the heater 200 may include a positive temperature coefficient (PTC) heater. The heater 200 may include a relay that may adjust whether the voltage is applied.

According to the embodiment, the cooler 300 may allow cooling water to circulate so as to cool the hydrogen tank 100. The cooler 300 may include cooling lines 310 and 320 including the first cooling line 310 and the second cooling line 320, a pump 330, and a branching valve 340.

An electrical component 20, a radiator fan 30, the pump 330, and the branching valve 340 may be positioned on the cooling lines 310 and 320.

Through the first cooling line 310, the cooling water may flow and pass through the electrical component 20. Here, the electrical component 20 may be understood as a component that uses, as an energy source, power of a vehicle or the like with which the fuel cell system 1 is equipped, and the present disclosure is not restricted or limited by the type and number of the electrical component 20.

The second cooling line 320 may be connected to the first cooling line 310 and may pass through the hydrogen tank 100. For example, the second cooling line 320 may form a line in a manner in which the second cooling line 320 surrounds an outside of the hydrogen tank 100, and the hydrogen tank 100 may be cooled or heated through heat exchange with the second cooling line 320 while the cooling water circulates through the second cooling line 320. In general, the temperature of the cooling water circulating through the second cooling line 320 is smaller than the temperature of the hydrogen tank 100, and thus the cooling water may cool the hydrogen tank 100. However, when the temperature of the hydrogen tank 100 is low due to weather, the temperature of the cooling water is higher than the temperature of the hydrogen tank 100, and thus the temperature of the hydrogen tank 100 may increase.

The pump 330 may be disposed on the cooling line and pump the cooling water. The pump 330 may pump the cooling water to allow the cooling water to circulate through the cooling line. To this end, the pump 330 may include a pumping device that may pump the cooling water, and the type and characteristics of the pump 330 are not restricted or limited. The pump 330 may be disposed on the first cooling line 310.

The branching valve 340 may adjust whether the cooling water circulates to the second cooling line 320. The branching valve 340 may adjust inflow of the cooling water into the second cooling line 320 through opening or closing thereof. For example, when the branching valve 340 is open, the cooling water pumped by the pump 330 may be introduced into the second cooling line 320. In contrast, when the branching valve 340 is closed, the cooling water may not be introduced into the second cooling line 320 and circulate through only the first cooling line 310. The branching valve 340 may be, for example, a three-way valve.

The radiator fan 30 for cooling the cooling water may be disposed on the cooling line. The radiator fan 30 may be formed in various structures that may cool the cooling water, and the type and structure of the radiator fan 30 are not restricted or limited. The radiator fan 30 may be disposed on the first cooling line 310.

According to the embodiment, the controller 400 may control the heater 200 and the cooler 300 based on the temperature of the hydrogen tank 100 to control the temperature of the hydrogen tank 100. In this case, the controller 400 may control supply of the voltage to the heater 200, control whether the branching valve 340 of the cooler 300 is opened or closed, and control the number of rotations of the pump 330.

According to the embodiment, the controller 400 may be a hardware device such as a processor, a micro processor unit (MPU), a micro controller unit (MCU), a central processing unit (CPU), and an electronic controller unit (ECU) or a program implemented by the processor. The controller 400 may be connected to respective components of the fuel cell system and perform overall functions related to adjustment of the temperature of the hydrogen tank 100. As an example, the controller 400 may be a fuel cell control unit (FCU) that controls the overall functions of the fuel cell system.

According to the embodiment, the controller 400 may communicate with the respective components, for example, the heater 200, the cooler 300, and the like, constituting the fuel cell system 1 by wire or wirelessly, and may perform the communication based on, for example, controller area network (CAN) communication.

According to the embodiment, the controller 400 may perform a control so as not to supply the voltage to the heater 200 when a state of fuel (SoF) of the hydrogen tank 100 is smaller than a first value and a charging rate of a battery (not illustrated) is smaller than a second value. Here, the battery may refer to a power source provided in the fuel cell system 1 and operated complementarily with the fuel cell stack. In this case, the first value and the second value may be experientially set by experiments or the like and may be set to 10% as an example. According to the embodiment, the first value and the second value may change according to an external pressure acquired by a pressure sensor 500. In the case of the fuel cell system provided in an object operating in the sky, such as a flight vehicle, a pressure changes according to the altitude, the hydrogen stored in the hydrogen tank 100 is a gas, and thus a volume may change according to the pressure. Thus, in the fuel cell system 1, the first value and the second value may change according to the external pressure, and a relationship between the external pressure and the first value and the second value may be stored in a lookup table or the like.

When the SoF of the hydrogen tank 100 is smaller than the first value and the charging rate of the battery (not illustrated) is smaller than the second value, it may be determined that a current that may be generated by the fuel cell stack is limited due to lack of the hydrogen and the charging rate of the battery is also insufficient. Thus, the controller 400 may control the remaining hydrogen and the remaining power to be used for a more important function (e.g., fail-safety) of the fuel cell system 1 without using the remaining hydrogen and remaining power to increase the temperature of the hydrogen tank 100.

According to the embodiment, the controller 400 may control the supply of the voltage to the heater 200 and the opening of the branching valve 340 not to occur simultaneously. The fuel cell system 1 is adapted to control the heater 200 and the cooler 300 to stably adjust the temperature of the hydrogen tank 100, and preferably, is adapted to maintain a constant temperature. Thus, when the hydrogen tank 100 is simultaneously heated and cooled through the heater 200 and the cooler 300, the adjustment of the temperature of the hydrogen tank 100 may become difficult.

According to the embodiment, the controller 400 may control whether to supply the voltage to the heater 200 based on the temperature of the hydrogen tank 100 and an outside air temperature. For example, only when the SoF of the hydrogen tank 100 is not smaller than the first value and the charging rate of the battery is not smaller than the second value, the controller 400 may perform such control. The outside air temperature may refer to a temperature outside the fuel cell system 1 (e.g., a temperature in the air). For example, when the temperature of the hydrogen tank 100 is smaller than a target temperature for maintaining a constant temperature, the controller 400 may supply the voltage to the heater 200. In another example, when the hydrogen tank 100 is maintained at a constant target temperature but the outside air temperature is significantly smaller than the current temperature of the hydrogen tank 100, the controller 400 may supply the voltage to the heater 200. The above control condition is merely an example, and the present disclosure is not limited thereto.

According to the embodiment, when the temperature of the hydrogen tank 100 is smaller than a third value and the outside air temperature is smaller than a fourth value, the controller 400 may perform a control to supply the voltage to the heater 200 to heat the hydrogen tank 100. In this case, the controller 400 may determine that the temperature of the hydrogen tank 100 is low and no or low natural temperature increase effect due to the outside air temperature is present and thus may perform a control to supply the voltage to the heater 200. In this case, the third value and the fourth value may be experientially set by experiments or the like and may be set to 0 degree as an example.

According to the embodiment, the fuel cell system 1 may further include the pressure sensor 500. The pressure sensor 500 may measure the external pressure. The external pressure may refer to the external pressure of the fuel cell system 1.

According to the embodiment, the controller 400 may estimate an altitude based on the external pressure and calculate the outside air temperature based on the estimated altitude. The fuel cell system 1 may also include a separate temperature sensor for acquiring the outside air temperature and also estimate the outside air temperature based on the pressure acquired by the pressure sensor 500.

According to the embodiment, the controller 400 may control to supply the voltage to the heater 200 and then may stop the supply of the voltage to the heater 200 when the temperature of the hydrogen tank 100 reaches a target value. Here, the target value may refer to a target temperature for maintaining the hydrogen tank 100 at a constant temperature and may be preset. According to the embodiment, the target value may be the temperature of the cooling water. The cooling water circulates through the cooling lines 310 and 320, and the cooling water in the fuel cell system 1 is set to be maintained at a constant temperature. Thus, the fuel cell system 1 may set the target value as the temperature of the cooling water, and therefore, when the cooling water circulates through the second cooling line 320, the hydrogen tank 100 may be maintained at the temperature of the cooling water.

According to the embodiment, the controller 400 may control whether the branching valve 340 is opened based on the temperature of the hydrogen tank 100 and the temperature of the cooling water. For example, when the temperature of the hydrogen tank 100 is higher than the temperature of the cooling water, the controller 400 may perform a control to open the branching valve 340 to cool the hydrogen tank 100.

According to the embodiment, when a value calculated based on a temperature change rate of the hydrogen tank 100 and a difference between the temperature of the hydrogen tank 100 and the temperature of the cooling water is greater than a fifth value, the controller 400 may perform a control to open the branching valve 340. For example, the controller 400 may determine whether to open the branching valve 340 by comparing value x expressed as in Equation 1 below with the fifth value. In a process of heating the hydrogen tank 100 by the heater 200, when conditions in which the temperature of the hydrogen tank 100 reaches a value close to the target value but a temperature increase rate is large and in which the temperature of the hydrogen tank 100 is higher than the temperature of the cooling water are satisfied, the controller 400 may perform a control to open the branching valve 340 to allow the cooling water to circulate through the second cooling line 320.

$$x = \vert \frac{da}{dt} \vert + ( a - b ) \cdot α \qquad [ Equation 1 ]$$

Here, “a” denotes the temperature of the hydrogen tank, ‘b” denotes the temperature of the cooling water,

$$\vert \frac{da}{dt} \vert$$

denotes the temperature change rate of the hydrogen tank, and α denotes a proportional constant.

According to the embodiment, when the branching valve 340 is opened, the controller 400 may correct the number of rotations of the pump 330 based on a length of the first cooling line 310 and a length of the second cooling line 320. The length of the cooling line through which the cooling water circulates (the length of the first cooling line+the length of the second cooling line) when the branching valve 340 is opened is greater than the length of the cooling line through which the cooling water circulates (the length of the first cooling line) when the branching valve 340 is closed. Thus, to provide the same cooling effect by the circulation of the cooling water, the number of rotations of the pump 330 is corrected to increase the amount of circulating cooling water. For example, when the number of rotations of the pump 330 is “r” in a state in which the branching valve 340 is closed, the controller 400 may correct the number of rotations of the pump 330 when the branching valve 340 is opened to

$$r \cdot \frac{length of first cooling line + length of second cooling line}{length of first cooling line}$$

According to the embodiment, the controller 400 may correct the number of rotations of the pump 330 further based on the temperature of the hydrogen tank 100 and the temperature of the cooling water. The fact that the controller 400 corrects the number of rotations of the pump 330 based on the length of the first cooling line 310 and the length of the second cooling line 320 may be understood to prevent the cooling effect from being degraded because the cooling line is lengthened due to the opening of the branching valve 340. In this case, since the cooling water should further cool the hydrogen tank 100 due to the opening of the branching valve 340, the controller 400 may correct the number of rotations of the pump 330 further in consideration of the temperature of the hydrogen tank 100. For example, as a difference between the temperature of the hydrogen tank 100 and the temperature of the cooling water increases, more circulation of the cooling water may be required while the cooling water cools the hydrogen tank 100, and accordingly, the controller 400 may correct the number of rotations of the pump 330 to increase. As an example, the controller 400 may correct the number of rotations of the pump 330 according to Equation 2 below.

$${r}^{′} \cdot ( r \cdot \frac{\begin{matrix}length of first cooling line + \\ length of second cooling line\end{matrix}}{length of first cooling line} ) * ( ( a - b ) * β ) \qquad [ Equation 2 ]$$

Here, “r” denotes the number of rotations of the pump 330 before the branching valve 340 is opened, r′ denotes the number of rotations of the pump 330 after the branching valve 340 is opened, “a” denotes the temperature of the hydrogen tank, “b” denotes the temperature of the cooling water, β denotes a proportional constant, and * denotes an operation rule. For example, the operation rule * may be various mathematical operators such as addition, subtraction, multiplication, root, and differential signs or combinations thereof.

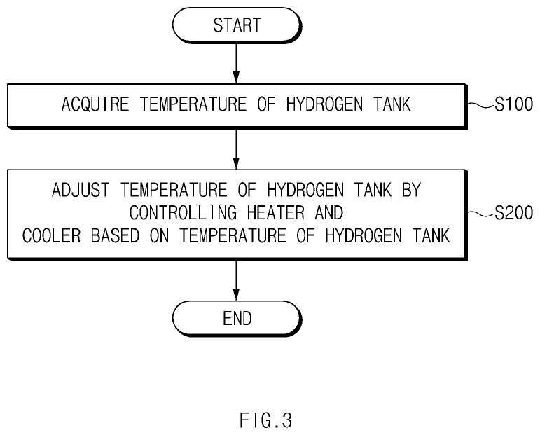

FIG. 3 is a flowchart for describing a hydrogen tank temperature controlling method of the fuel cell system according to the embodiment disclosed in the present document.

Referring to FIG. 3, a hydrogen tank temperature controlling method of the fuel cell system may include operation S100 of acquiring the temperature of the hydrogen tank and operation S200 of adjusting the temperature of the hydrogen tank by controlling the heater and the cooler based on the temperature of the hydrogen tank.

In operation S100, the controller 400 may acquire the temperature of the hydrogen tank 100. For example, the controller 400 may receive the temperature of the hydrogen tank 100 from the temperature sensor 10.

In operation S200, the controller 400 may control the heater 200 and the cooler 300 based on the temperature of the hydrogen tank 100 to adjust the temperature of the hydrogen tank 100. The controller 400 may control the supply of the voltage to the heater 200, control whether the branching valve 340 of the cooler 300 is opened or closed, and control the number of rotations of the pump 330.

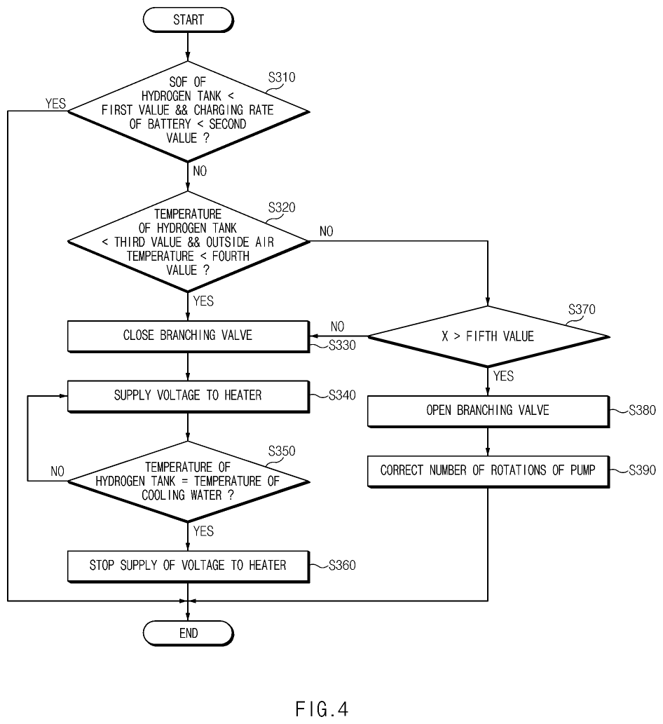

FIG. 4 is a flowchart for describing a process of controlling a temperature of a hydrogen tank according to the embodiment disclosed in the present document.

Referring to FIG. 4, the fuel cell system 1 may control the heating and cooling of the hydrogen tank 100 so that the temperature of the hydrogen tank 100 may be maintained at a constant temperature.

In operation S310, the controller 400 may determine whether the SoF of the hydrogen tank 100 is smaller than the first value and whether the charging rate of the battery is smaller than the second value. The controller 400 may terminate a procedure when the SoF of the hydrogen tank 100 is smaller than the first value and the charging rate of the battery is smaller than the second value (S310-Yes). The controller 400 may proceed to operation S320 when the SoF of the hydrogen tank 100 is greater than or equal to the first value and the charging rate of the battery is greater than or equal to the second value (S310-No).

In operation S320, the controller 400 may determine whether the temperature of the hydrogen tank 100 is smaller than the third value and whether the outside air temperature is smaller than the fourth value. The controller 400 may proceed to operation S330 when the temperature of the hydrogen tank 100 is smaller than the third value and the outside air temperature is smaller than the fourth value (S320-Yes). The controller 400 may proceed to S370 when the temperature of the hydrogen tank 100 is greater than or equal to the third value or the outside air temperature is greater than or equal to the fourth value (S320-No).

In operation S330, the controller 400 may close the branching valve 340. When the branching valve 340 is already closed, the controller 400 may skip operation S330.

In operation S340, the controller 400 may supply the voltage to the heater 200. The controller 400 may increase the temperature of the hydrogen tank 100 through the heater 200.

In operation S350, the controller 400 may determine whether the temperature of the hydrogen tank 100 reaches the target value. The target value may be the temperature of the cooling water, and the controller 400 may determine whether the temperature of the hydrogen tank 100 reaches the temperature of the cooling water. The controller 400 may proceed to operation S360 when the temperature of the hydrogen tank 100 reaches the target value (S350-Yes). When the temperature of the hydrogen tank 100 does not reach the target value, the controller 400 may return to operation S340 to maintain the supply of the voltage to the heater 200.

In operation S360, the controller 400 may stop the supply of the voltage to the heater 200.

In operation S370, the controller 400 may determine whether value “x” is greater than the fifth value. Value “x” may be a value calculated based on the temperature change rate of the hydrogen tank 100 and a difference between the temperature of the hydrogen tank 100 and the temperature of the cooling water. The controller 400 may proceed to operation S380 when value “x” is greater than the fifth value (S370-Yes). The controller 400 may proceed to operation S330 when value “x” is smaller than or equal to the fifth value (S350-No).

In operation S380, the controller 400 may perform a control to open the branching valve 340. The controller 400 may open the branching valve 340 to cool the hydrogen tank 100.

In operation 390, the controller 400 may correct the number of rotations of the pump 330. The controller 400 may correct the number of rotations of the pump 330 to provide an optimum cooling effect through the circulation of the cooling water.

In a fuel cell system according to embodiments disclosed in the present document, a temperature of a hydrogen tank may be adjusted, and accordingly, the hydrogen tank may be maintained at a constant temperature.

In the fuel cell system according to embodiments disclosed in the present document, the hydrogen tank may be maintained at a constant temperature, a state of the hydrogen tank may be accurately determined, and accordingly, inaccurate control of the fuel cell system may be prevented.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A fuel cell system, comprising:
a hydrogen tank configured to store hydrogen supplied to a fuel cell stack;
a heater configured to heat the hydrogen tank;
a cooler configured to cool the hydrogen tank by circulating cooling water; and
a controller configured to adjust a temperature of the hydrogen tank by controlling the heater and the cooler responsive to a measured temperature of the hydrogen tank.

2. The fuel cell system of claim 1, wherein the cooler comprises:
a cooling line comprising a first cooling line through which the cooling water circulates to pass through an electrical component and a second cooling line connected to the first cooling line and configured to circulate the cooling water through the hydrogen tank;
a pump disposed on the cooling line and configured to pump the cooling water; and
a branching valve configured to open or close to circulate the cooling water within the second cooling line.

3. The fuel cell system of claim 2, wherein the controller is configured to not supply a voltage to the heater when a state of fuel (SoF) of the hydrogen tank is less than a first value and a charging rate of a battery is less than a second value.

4. The fuel cell system of claim 2, wherein the controller is configured to not supply a voltage to the heater and open the branching valve at the same time.

5. The fuel cell system of claim 2, wherein the controller is configured to control whether a voltage is supplied to the heater based on the temperature of the hydrogen tank and an outside air temperature.

6. The fuel cell system of claim 5, further comprising:
a pressure sensor configured to measure an external pressure,
wherein the controller is configured to estimate an altitude based on the external pressure and calculate the outside air temperature based on the estimated altitude.

7. The fuel cell system of claim 5, wherein the controller is configured to supply the voltage to the heater so as to heat the hydrogen tank when the temperature of the hydrogen tank is less than a third value and the outside air temperature is less than a fourth value.

8. The fuel cell system of claim 7, wherein the controller is configured to stop the supply of the voltage to the heater when the temperature of the hydrogen tank reaches a target value.

9. The fuel cell system of claim 8, wherein the target value is a temperature of the cooling water.

10. The fuel cell system of claim 2, wherein the controller is configured to open the branching valve is opened based on the temperature of the hydrogen tank and a temperature of the cooling water.

11. The fuel cell system of claim 10, wherein the controller is configured to open the branching valve to allow the cooling water to circulate to the second cooling line responsive to a calculated value being greater than a fifth value, the calculated value being based on a temperature change rate of the hydrogen tank and a difference between the temperature of the hydrogen tank and the temperature of the cooling water.

12. The fuel cell system of claim 10, wherein the controller is configured to correct a number of rotations of the pump based on a length of the first cooling line and a length of the second cooling line when the branching valve is opened.

13. The fuel cell system of claim 12, wherein the controller is configured to correct the number of rotations of the pump further based on the temperature of the hydrogen tank and the temperature of the cooling water.

14. The fuel cell system of claim 1, wherein the heater comprises a positive temperature coefficient (PTC) heater.

15. A processor-implemented method, the method comprising:
acquiring a temperature of a hydrogen tank; and
controlling one of a heater configured to heat the hydrogen tank and a cooler configured to cool the hydrogen tank responsive to the temperature of the hydrogen tank.

16. The method of claim 15, further comprising adjusting a branching valve to allow cooling water to circulate to a first cooling line responsive to a calculated value being greater than a first value, the calculated value being based on a temperature change rate of the hydrogen tank and a difference between the temperature of the hydrogen tank and a temperature of the cooling water.

17. A device, comprising:
a processor configured to execute instructions; and
a memory storing the instructions, wherein execution of the instructions configures the processor to:
receive a measured temperature of a hydrogen tank; and
adjust a temperature of the hydrogen tank by controlling a heater and a cooler responsive to the measured temperature of the hydrogen tank;
a first cooling line receiving cooling water from the cooler, the first cooling line being configured to circulate the cooling water through an electrical component;
a branching valve configured to selectively provide the cooling water circulates to a second cooling line; and
the second cooling line receiving the cooling water through the branching valve and being configured to circulate the cooling water through the hydrogen tank.
